(19) United States
(12) Patent Application Publication
(10) Pub. No.: US 2017/0077492 A1
(43) Pub. Date: Mar. 16, 2017

(54) POSITIVE ELECTRODE FOR NON-AQUEOUS ELECTROLYTE SECONDARY BATTERY AND NON-AQUEOUS ELECTROLYTE SECONDARY BATTERY USING THE SAME

(71) Applicant: SANYO Electric Co., Ltd., Daito-shi, Osaka (JP)

(72) Inventors: Takatoshi Higuchi, Hyogo (JP); Takeshi Ogasawara, Hyogo (JP)

(73) Assignee: SANYO Electric Co., Ltd., Daito-shi, Osaka (JP)

(21) Appl. No.: 15/121,997

(22) PCT Filed: Feb. 13, 2015
(86) PCT No.: PCT/JP2015/000655

§ 371 Date: Aug. 26, 2016

(30) Foreign Application Priority Data
Feb. 28, 2014 (JP) 2014-037868

(51) Int. Cl. H01M 4/131; H01M 4/525; H01M 4/36; H01M 4/485; H01M 4/62; H01M 10/0525; H01M 4/505

(52) U.S. Cl. CPC H01M 4/131; H01M 10/0525; H01M 4/525; H01M 4/505; H01M 4/485; H01M 4/625; H01M 4/366; H01M 2004/028

(57) ABSTRACT

Provided is a positive electrode for a non-aqueous electrolyte secondary battery, with which the increase in DC resistance of a non-aqueous electrolyte secondary battery after cycles is suppressed. According to one aspect of the present invention, a positive electrode for a non-aqueous electrolyte secondary battery includes a lithium transition metal oxide that contains an element that belongs to group 6 of the periodic table and a boron-containing carbon material as a conductive agent. Examples of the element that belongs to group 6 of the periodic table include chromium, molybdenum, and tungsten. Among these, tungsten is preferable.

### TECHNICAL FIELD

The present invention relates to a positive electrode for a non-aqueous electrolyte secondary battery, and a non-aqueous electrolyte secondary battery using the positive electrode.

### BACKGROUND ART

Recent years have seen rapid advancement in size- and weight-reduction of mobile phones, including smart phones, and mobile appliances such as notebook computers. Secondary batteries used as driving power supplies for these appliances are being required to achieve ever higher capacities. Non-aqueous electrolyte secondary batteries, which charge and discharge power as lithium ions travel between a positive electrode and a negative electrode, have high energy density and high capacity and thus are widely used as driving power supplies of mobile information terminals such as those described above.

Recently, non-aqueous electrolyte secondary batteries are drawing much attention as the power supplies for powering power tools, electric vehicles (EVs), hybrid electric vehicles (HEVs and PHEVs), etc., and expected to be applied in a wider range of usage. Such power supplies for powering are required to achieve a high capacity that enables long-time operation and an improved output property when high-current charge and discharge cycles are repeated in a relatively short period of time. In particular, for use in power tools, EVs, HEVs, PHEVs, etc., power supplies that can achieve high capacity, high output, high durability, high safety, etc., are indispensable.

For example, PTL 1 described below discloses a positive electrode active material that contains a lithium complex oxide of nickel, cobalt, and manganese, and one or both of W and Mo. The literature suggests that a non-aqueous electrolyte secondary battery with excellent heat stability and initial capacity can be provided due to this material.

PTL 2 described below suggests that when a positive electrode mixture contains boron-containing carbon black as a conductive agent, a non-aqueous electrolyte secondary battery with an improved high-temperature storage property can be provided.

### CITATION LIST

### Patent Literature

PTL 1: International Publication No. 2002/041419

PTL 2: Japanese Published Unexamined Patent Application 2002-203551

### SUMMARY OF INVENTION

### Technical Problem

However, even with the technologies disclosed in PTL 1 and PTL 2, an increase in DC resistance after cycles cannot be suppressed, which is a problem.

### Solution to Problem

In order to address the problem described above, one aspect of the present invention provides a positive electrode for a non-aqueous electrolyte secondary battery, the positive electrode containing a lithium transition metal oxide that contains an element that belongs to group 6 in the periodic table, and a boron-containing carbon material as a conductive agent.

### Advantageous Effects of Invention

According to one aspect of the present invention, a non-aqueous electrolyte secondary battery whose increase in DC resistance after cycles is suppressed is provided.

### BRIEF DESCRIPTION OF DRAWINGS

FIG. 1 is a schematic diagram illustrating a three-electrode test cell of Example 1.

### DESCRIPTION OF EMBODIMENTS

Embodiments of the present invention will now be described. The embodiments are merely illustrative examples of implementation of the present invention and do not limit the present invention. Without departing from the gist of the present invention, various modifications and alterations are possible in the implementation. The drawing referred to in the description of the embodiments is schematic and the scale of the constitutional parts illustrated in the drawing may be different from the actual scale.

### <Non-Aqueous Electrolyte Secondary Battery>

One example of the non-aqueous electrolyte secondary battery according to an embodiment of the present invention includes a positive electrode, a negative electrode capable of storing and releasing lithium, and a non-aqueous electrolyte. A non-aqueous electrolyte secondary battery, which is an example of this embodiment, has a structure in which an electrode assembly prepared by winding or stacking a positive electrode and a negative electrode with a separator therebetween, and a non-aqueous electrolyte solution, which is a non-aqueous electrolyte in a liquid form, are enclosed in a battery outer can, but is not limited to this structure. Constitutional components of the non-aqueous electrolyte secondary battery are described in detail below.

### [Positive Electrode]

An example of the positive electrode for a non-aqueous electrolyte secondary battery according to an embodiment of the present invention contains a lithium transition metal oxide containing an element belonging to group 6 of the periodic table (hereinafter may also be referred to as the “group 6 element”), and a boron-containing carbon material as the conductive agent.

Since the lithium transition metal oxide contains the group 6 element, ion conductivity is improved and the catalytic property of the transition metal contained in the lithium transition metal oxide is lowered. Moreover, because the boron-containing carbon material is present near the surface of the lithium transition metal oxide (near the group 6 element) at this stage, leaching of the group 6 element from the surfaces and surface layers of the lithium transition metal oxide particles is suppressed during charge and discharge cycles, and enhancement of the catalytic property of the lithium transition metal oxide can be suppressed. As a result, the decomposition reaction between the lithium transition metal oxide and the electrolyte solution is suppressed, and thus formation of excessive coating films composed of decomposition products on the surfaces of the lithium transition metal oxide, which leads to formation of resistance, can be suppressed.

As described above, when the lithium transition metal oxide contains the group 6 element, an effect of lowering the catalytic property of the lithium transition metal oxide is exhibited. Consequently, the activity of the boron-containing carbon material in contact with the particle surfaces of the lithium transition metal oxide can also be lowered. As a result, the decomposition reaction between the electrolyte solution and the boron-containing carbon material is suppressed, and excessive formation of coating films composed of decomposition products on the surfaces of the carbon material, which leads to formation of resistance, can be suppressed.

That is, due to the synergistic effect of the group 6 element contained in the lithium transition metal oxide and use of a boron-containing carbon material as the conductive agent, excessive film formation on the surfaces of the lithium transition metal oxide and the carbon material is suppressed and good coating films with excellent lithium ion permeability are presumably formed. Presumably as a result, the increase in DC resistance after cycles can be suppressed.

The element that belongs to group 6 of the periodic table should be present at least on a surface or in a surface layer of the lithium transition metal oxide particle. In this manner, the effect of suppressing an increase in DC resistance after cycles is presumably obtained.

The element that belongs to group 6 may exist as particles of a compound that contains the group 6 element on the surface of the lithium transition metal oxide. The compound that contains the group 6 element may be partially dissolved in the lithium transition metal oxide (crystal) or may be merely physically attached to the surface of the lithium transition metal oxide without being dissolved. The group 6 element, regardless of whether it is dissolved in the crystals of the lithium transition metal oxide or physically attached as a compound to the surface of the lithium transition metal oxide, has an effect of lowering the catalytic property of the lithium transition metal oxide. The group 6 element dissolved in the crystals of the lithium transition metal oxide also has an effect of improving stability of the crystals in the cycles; thus, an effect of further suppressing an increase in resistance after cycles is also obtained.

Examples of the element that belongs to group 6 of the periodic table include chromium, molybdenum, and tungsten. When these elements are contained in the lithium transition metal oxide, the catalytic property of the lithium transition metal oxide can be lowered. In particular, the group 6 element is preferably tungsten. This is because tungsten further lowers the catalytic property of the transition metal contained in the lithium transition metal oxide.

The compound that contains an element that belongs to group 6 of the periodic table is not particularly limited and examples of the compound include oxides, borides, carbides, silicides, sulfides, and chlorides of the group 6 elements. Specific examples thereof include tungsten oxide, lithium tungstate, sodium tungstate, magnesium tungstate, potassium tungstate, silver tungstate, tungsten boride, tungsten carbide, tungsten silicide, tungsten sulfide, tungsten chloride, molybdenum oxide, lithium molybdate, sodium molybdate, molybdenum carbide, and molybdenum chloride. Among these, from the viewpoint of preventing inclusion of impurities other than lithium and the group 6 elements into the lithium transition metal oxide, tungsten oxide, lithium tungstate, molybdenum oxide, and lithium molybdate are more preferable.

The amount of the element that belongs to group 6 of the periodic table contained in the lithium transition metal oxide is preferably 0.05 mol % or more and 10.0 mol % or less and more preferably 0.20 mol % or more and 1.5 mol % or less relative to the total number of moles of the metal elements in the lithium transition metal oxide other than lithium. This is because when the amount of the group 6 element is less than 0.05 mol %, the effect of suppressing an increase in DC resistance after cycles may not be fully exhibited. Moreover, when the amount of the group 6 element exceeds 10.0 moil, the decrease in initial capacitance per mass becomes significant.

An example of the lithium transition metal oxide used as the positive electrode active material is a compound that contains, as a transition metal, at least one element selected from the group consisting of nickel (Ni), manganese (Mn), and cobalt (Co). The lithium transition metal oxide may contain a non-transition metal such as aluminum (Al) or magnesium (Mg). Specific examples include lithium cobaltate, and Ni—Co—Mn, Ni—Co—Al, and Ni—Mn—Al lithium transition metal oxides. An olivine-type lithium transition metal complex metal oxide that contains iron (Fe), manganese (Mn), or the like (represented by LiMPO₄ where M represents an element selected from Fe, Mn, Co, and Ni) may be used as the lithium transition metal oxide. These materials may be used alone or in combination.

Among these, Ni—Co—Al lithium transition metal oxides are preferable for their high capacity and excellent output properties. Ni—Co—Mn lithium transition metal oxides are particularly preferable for their excellent output properties and regenerative properties. Examples of the Ni—Co—Mn lithium transition metal oxides include known compositions whose Ni:Co:Mn molar ratio is 1:1:1, 5:2:3, 4:4:2, 5:3:2, 6:2:2, 55:25:20, 7:2:1, 7:1:2, or 8:1:1. In particular, in order to allow the positive electrode capacity to increase, a material containing more Ni or Co than Mn is preferably used and a material in which the difference in molar ratio between Ni and Mn relative to the total number of moles of Ni, Co, and Mn is 0.04% or more is preferable.

Examples of the Ni—Co—Al lithium transition metal oxides include known compositions whose Ni:Co:Al ratio is 82:15:3, 82:12:6, 80:10:10, 80:15:5, 87:9:4, 90:5:5, or 95:3:2.

The lithium transition metal oxide may contain other additive elements. Examples of the additive elements include boron, magnesium, aluminum, titanium, vanadium, iron, copper, zinc, niobium, zirconium, tin, tantalum, sodium, potassium, barium, strontium, and calcium.

The positive electrode active material is not limited to a single lithium transition metal oxide containing a group 6 element. Any compound capable of reversible intercalation and deintercalation of lithium ions can be used as other positive electrode active materials.

Examples of the method for causing the lithium transition metal oxide to contain an element that belongs to group 6 of the periodic table include a method of firing a mixture of a lithium compound, a transition metal oxide, and a compound of a group 6 element, a method of mechanical mixing a lithium transition metal oxide and a compound of a group 6 element, a method of mixing a lithium transition metal oxide and an aqueous solution prepared by dissolving a salt of a group 6 element, and a method of adding a compound of a group 6 element during preparation of the positive electrode mixture slurry and then mixing the resulting mixture.

The boron-containing carbon material may exist by making contact with the particle surfaces of the lithium transition metal oxide. The boron-containing carbon material may be in direct contact with the particle surfaces of the lithium transition metal oxide or tungsten may be present between the boron-containing carbon material and the particle surfaces of the lithium transition metal oxide.

A carbon material containing dissolved boron or a carbon material having boron attached to the surface thereof without being dissolved in the carbon material may be used as the boron-containing carbon material. Alternatively, a carbon material containing dissolved boron and having a surface to which some undissolved boron is attached may be used as the boron-containing carbon material. Of these, a carbon material at least containing dissolved boron is particularly preferable since the effect of suppressing leaching of the tungsten is enhanced. In the carbon material containing dissolved boron, some of the carbon atoms of the carbon material are substituted by dissolved boron atoms.

The boron content in the carbon material relative to the total mass of the carbon material is preferably 0.3% by mass or more and 2.0% by mass or less and more preferably 0.5% by mass or more and 1.5% by mass or less. This is because when the boron content is less than 0.3% by mass, the tungsten leaching suppressing effect brought by incorporation of boron may become insufficient. Moreover, when the boron content exceeds 2.0% by mass, the resistance of the carbon material may increase.

Examples of the method for causing a carbon material to contain boron include a method in which a carbon source and a vaporized boron compound are mixed in vapor phase to carry out pyrolytic reaction and a method in which a mixture of a carbon compound and a boron compound is fired. The former, namely, the vapor phase reaction, is more preferable since the amount (content) of boron dissolved in the carbon material is further increased and the tungsten leaching suppressing effect is enhanced.

A hydrocarbon gas can be used as the carbon source, for example, and ethylene gas and acetylene gas are particularly preferable.

Examples of the boron compound include boron, boron oxide, boric acid, triethyl borate, trimethyl borate, triethyl borane, tributyl borane, boron trichloride, boron trifluoride, and diborane. Of these, when a boron compound is vaporized and used, organic boron compounds such as triethyl borate, trimethyl borate, and triethyl borane are preferably used since they are easy to vaporize.

Examples of the carbon compound include carbon black such as acetylene black, Ketjen black, and furnace carbon, and graphites such as natural graphite and artificial graphite.

The conductive agent does not have to be a single boron-containing carbon material. Examples of other conductive agents include carbon black such as acetylene black, Ketjen black, and furnace carbon, graphites such as natural graphite and artificial graphite, conductive fibers such as carbon fibers and metal fibers, and organic conductive materials such as polyphenylene derivatives.

### [Negative Electrode]

The negative electrode active material to be used in a negative electrode for the non-aqueous electrolyte secondary battery of the present invention may be a negative electrode active material typically used, and examples thereof include carbon materials that can store and release lithium, metals that can form alloys with lithium, and alloy compounds that contain such metals. Examples of the carbon material include natural graphites such as natural graphite, ingraphitizable carbon, and artificial graphite, and coke. Examples of the alloy compounds include compounds that contain at least one metal that can form an alloy with lithium. The element that can form an alloy with lithium is preferably silicon or tin, or an alloy of silicon or tin. Another carbon material (amorphous carbon, low-crystalline carbon, or the like) can be scattered or overlaid on the surface of the carbon material or the alloy compound. Alternatively, a mixture of the carbon material and a compound of silicon or tin may be used. Alternatively, although energy density may decrease, a material, such as lithium titanate, that has a charge-discharge potential with respect to metallic lithium higher than that of the carbon material may be used as the negative electrode material.

As well as silicon and silicon alloys described above, silicon oxides (SiOₓ, where 0<x<2 and preferably 0<x<1) may be used as the negative electrode active material. Thus, silicon in silicon oxides represented by SiOₓ (0<x<2) (SiOₓ=(Si)_{1-1/2x}+(SiO₂)_{1/2x}) is included in silicon described above. The negative electrode active material is preferably mainly a carbon material, in particular, graphite. In this manner, when combined with a lithium transition metal oxide used as the positive electrode active material, output regenerative properties can be maintained over a wide range of the depths of charge and discharge.

A negative electrode mixture layer that contains the negative electrode active material described above may also contain a known carbon conductive material, such as graphite, and a known binder, such as sodium carboxymethyl cellulose (CMC) or styrene butadiene rubber (SBR).

### [Non-Aqueous Electrolyte]

Examples of the solvent for non-aqueous electrolyte include cyclic carbonates such as ethylene carbonate, propylene carbonate, butylene carbonate, and vinylene carbonate, and chain carbonates such as dimethyl carbonate, methyl ethyl carbonate, and diethyl carbonate. In particular, a mixed solvent of a cyclic carbonate and a chain carbonate is preferably used as a non-aqueous solvent that has low viscosity, low melting point, and high lithium ion conductivity. The cyclic carbonate-to-chain carbonate volume ratio in the mixed solvent is preferably limited to be in the range of 2:8 to 5:5. Moreover, a compound containing an ester, such as methyl acetate, ethyl acetate, propyl acetate, methyl propionate, ethyl propionate, or γ-butyrolactone, can be used in combination with the solvent described above. A sulfone-group-containing compound such as propane sultone, or an ether-containing compound such as 1,2-dimethoxyethane, 1,2-diethoxyethane, tetrahydrofuran, 1,3-dioxane, 1,4-dioxane, or 2-methyltetrahydrofuran can be used in combination with the solvent described above. A nitrile-containing compound, such as butyronitrile, valeronitrile, n-heptanenitrile, succinonitrile, glutaronitrile, adiponitrile, pimelonitrile, 1,2,3-propanetricarbonitrile, or 1,3,5-pentatricarbonitrile, or an amide-containing compound such as dimethylformamide can be used in combination with the solvent described above. A solvent in which some of hydrogen (H) atoms of any of these compounds are substituted with fluorine (F) atoms can also be used.

The solute for the non-aqueous electrolyte may be any common solute. Examples thereof include LiPF₆, LiCF₃SO₃, LiN (FSO₂)₂, LiN (CF₃SO₂)₂, LiN (C₂F₅SO₂)₂, LiN (CF₃SO₂)(C₄F₉SO₂), LiC (C₂F₅SO₂)₃, and LiAsF₆. Moreover, a mixture of a fluorine-containing lithium salt and a lithium salt other than the fluorine-containing lithium salt (a lithium salt containing at least one element selected from P, B, O, S, N, and Cl (for example, LiClO₄ or LiPO₂F₂)) may be used. In particular, from the viewpoint of forming a stable coating film on a surface of a negative electrode in a high-temperature environment, a fluorine-containing lithium salt and a lithium salt whose anion is an oxalato complex are preferably contained.

Examples of the lithium salt whose anion is an oxalato complex include lithium-bisoxalate borate (LiBOB), Li[B(C₂O₄)F₂], Li[P(C₂O₄)F₄], and Li[P(C₂O₄)₂F₂]. Among these, LiBOB, which helps form a stable coating film on the negative electrode, is preferably used.

### [Separator]

Examples of the separator include commonly used separators such as polypropylene or polyethylene separators, polypropylene-polyethylene multilayered separators, and separators coated with a resin, such as an aramid resin.

A layer composed of a commonly used inorganic filler can be formed at the interface between the positive electrode and the separator or between the negative electrode and the separator. Examples of the filler include commonly used fillers such as an oxide that uses one or a combination of aluminum, silicon, magnesium, etc., a phosphate compound, and an oxide or phosphate compound having a surface treated with a hydroxide or the like. Examples of the method for forming a filler layer include a method with which a filler-containing slurry is directly applied to a positive electrode, a negative electrode, or a separator, and a method with which a sheet composed of a filler is attached to a positive electrode, a negative electrode, or a separator.

### EXAMPLES

Examples of the present invention will now be described in further detail through experimental examples below, which do not limit the scope of the present invention. Various modifications and alterations are possible without departing from the gist of the invention.

### Experimental Example 1

### Preparation of Positive Electrode Active Material

First, a nickel cobalt manganese complex hydroxide represented by [Ni_{0.35}Co_{0.35}Mn_{0.30}] (OH)₂ obtained by co-precipitation was fired at 500° C. to obtain a nickel cobalt manganese complex oxide. Next, lithium carbonate, the nickel cobalt manganese complex oxide obtained as above, and tungsten oxide (WO₃) were mixed in an Ishikawa-type mortar so that the molar ratio of lithium to nickel cobalt manganese as the entire transition metal to tungsten was 1.20:1:0.005. Then the resulting mixture was heat-treated at 900° C. in air for 20 hours and then crushed to obtain a lithium nickel cobalt manganese complex oxide composed of tungsten-containing Li_{1.09}[Ni_{0.32}Co_{0.32}Mn_{0.27}] O₂. The crystal structure of the lithium nickel cobalt manganese complex oxide was analyzed through XRD. Tungsten was confirmed to be partly dissolved in the crystals since the lattice volume underwent changes compared to a tungsten-free lithium nickel cobalt manganese complex oxide represented by Li_{1.09}[Ni_{0.32}Co_{0.32}Mn_{0.27}] O₂. SEM-EDX confirmed that some of tungsten remained on the surface by forming compound particles.

### [Preparation of Conductive Agent]

Acetylene gas serving as a carbon source and vaporized trimethyl borate were mixed in advance so that the boron content relative to carbon was 1% by mass, and the resulting mixture was sprayed onto a reaction layer at about 2000° C. Then pyrolytic reaction was conducted in a reactor to obtain a carbon material that contains 1% by mass of boron relative to the carbon material. The boron content was determined by ashing the obtained carbon material and conducting ICP analysis of the solution prepared by dissolving the ash in hydrochloric acid under heating. The obtained carbon material contained dissolved boron with some boron remaining on and attaching to the surface of the carbon material without being dissolved.

[Preparation of Positive Electrode] The positive electrode active material obtained as such, a conductive agent, and polyvinylidene fluoride (PVdF) serving as a binder were added to an appropriate amount of N-methyl-2-pyrrolidone serving as a dispersant so that the mass ratio of the positive electrode active material to the conductive agent to the binder was 91:7:2, and the resulting mixture was kneaded to prepare a positive electrode mixture slurry. Then the positive electrode mixture slurry was evenly applied to one side of a positive electrode current collector formed of an aluminum foil, dried, and rolled with a rolling roller so that the packing density of the positive electrode mixture layer formed on one side of the positive electrode current collector was 2.6 g/cm³. A positive electrode tab was attached to a surface of the positive electrode current collector so as to prepare a positive electrode plate in which a positive electrode mixture layer was formed on one side of the positive electrode mixture layer.

### [Preparation of Three-Electrode Test Cell]

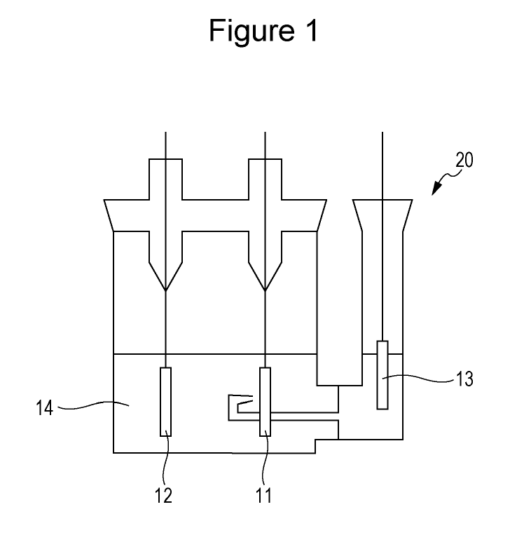

FIG. 1 illustrates a three-electrode test cell 20 in which the above-described positive electrode was used as a working electrode 11. A three-electrode test cell 20 was formed of the working electrode 11 serving as a positive electrode, a counter electrode 12 formed of metallic lithium serving as a negative electrode, and a reference electrode 13 being formed of metallic lithium. To prepare a non-aqueous electrolyte solution 14 of the three-electrode test cell 20, lithium phosphate hexafluoride (LiPF₆) was dissolved in an ethylene carbonate (EC)/methyl ethyl carbonate (MEC)/dimethyl carbonate (DMC) 3:3:4 (ν) mixed solvent so that the concentration was 1.0 mol/L. Then vinylene carbonate (VC) was added in an amount of 1% by mass relative to the total amount of the electrolyte solution and dissolved therein, and the resulting solution was used as the non-aqueous electrolyte solution.

A three-electrode test cell prepared as such is hereinafter referred to as a cell A1.

### Experimental Example 2

A three-electrode test cell was prepared as in Experimental Example 1 except that in preparing the positive electrode active material, tungsten oxide was not mixed.

A three-electrode test cell prepared as such is hereinafter referred to as a cell B1.

### Experimental Example 3

A three-electrode test cell was prepared as in Experimental Example 1 except that in preparing the conductive agent, a boron-free carbon material was obtained by pyrolytic reaction instead of mixing vaporized trimethyl borate.

A three-electrode test cell prepared as such is hereinafter referred to as a cell B2.

### Experimental Example 4

A three-electrode test cell was prepared as in Experimental Example 1 except that tungsten oxide was no mixed in preparing the positive electrode active material and that, in preparing a conductive agent, a boron-free carbon material was obtained by pyrolytic reaction instead of mixing vaporized trimethyl borate.

A three-electrode test cell prepared as such is hereinafter referred to as a cell B3.

### <Output Property Test>

### [Calculation of Initial DC Resistance]

Each of the cells A1 and B1 to B3 prepared as described above was charged and discharged under the following conditions and the initial DC resistance was calculated. (Initial charge/discharge conditions)

At a temperature of 25° C., constant-current charging was conducted at a current density of 0.2 mA/cm² until the positive electrode potential was 4.3 V (vs. Li/Li⁺) and then constant-voltage charging was conducted at a constant voltage of 4.3 V until the current density was 0.04 mA/cm². Then constant-current discharging was conducted at a current density of 0.2 mA/cm² until the cell voltage was 2.5 V. The Interval between the charging and discharging was 10 minutes.

Measurement of Initial DC Resistance

At a temperature of 25° C., the cell after the initial charge/discharge test was subjected to constant-current charging at a current density of 0.2 mA/cm² until the positive electrode potential was 4.3 V (vs. Li/Li⁺) and then to constant-voltage charging at a constant voltage of 4.3 V until the current density was 0.04 mA/cm². After 10 minutes of interval, the cell voltage was measured and the result was assumed to be the voltage before discharging. Then the cell was discharged at a current density of 5.0 mA/cm², and the cell voltage 0.1 seconds after was measured and assumed to be the voltage after discharging.

The change in voltage between before and after discharging was divided by 5.0 mA and the result was assumed to be the initial DC resistance.

[Calculation of DC Resistance after Cycles]

Each cell after measurement of the initial DC resistance was subjected to charge/discharge cycles under the following conditions, and the DC resistance after cycles was calculated. (Charge/discharge conditions)

At a temperature of 25° C., constant-current charging was conducted at a current density of 1.0 mA/cm² until the positive electrode potential was 4.3 V (vs. Li/Li⁺) and then constant-voltage charging was conducted at a constant voltage of 4.3 V until the current density was 0.04 mA/cm². Then constant-current discharging was conducted at a current density of 2.5 mA/cm² until the cell voltage was 2.5 V. Ten cycles of charge/discharge test was conducted under these charge/discharge conditions. The interval between charging and discharging was 10 minutes each.

Calculation of DC Resistance after Cycles

Each cell after the cycle test was measured in the same manner as determining the initial DC resistance to determine the voltage before discharging and the voltage after discharging. The DC resistance after cycles was then determined therefrom.

The change in DC resistance after cycles relative to the initial DC resistance was assumed to be the DC resistance elevation rate after cycles. The results are shown in Table 1. In the table, the DC resistance elevation rates after cycles of the cells A1, B1, and B2 are indicated as relative values on the presumption that the DC resistance elevation rate after cycles of the cell 3 is 100 (reference).

TABLE 1

| | | | DC resistance |
|---|---|---|---|
| | Incorporation | Incorporation of | elevation rate |
| Cell | of W | boron | after 10 cycles |
| A1 | Yes | Yes | 93 |
| B1 | Yes | No | 112 |
| B2 | No | Yes | 113 |
| B3 | No | No | 100 |

The results in Table 1 indicate that the cell A1, in which lithium nickel cobalt manganese complex oxide contains tungsten and a boron-containing carbon material is used as the conductive agent, has a small DC resistance elevation rate after cycles compared to the cell B1, in which the lithium nickel cobalt manganese complex oxide contains tungsten but a boron-free carbon material is used as the conductive agent, the cell B2, in which a boron-containing carbon material is used as the conductive agent but the lithium nickel cobalt manganese complex oxide does not contain tungsten, and the cell B3, in which neither was satisfied. The reason for such results are presumably as follows.

In the cell B1, the lithium nickel cobalt manganese complex oxide contains tungsten, but a boron-free carbon material is used as the conductive agent. In the cell B1, a boron-containing carbon material is not present near the tungsten compound remaining on the surface of the lithium nickel cobalt manganese complex oxide. Thus, as charging and discharging are repeated, tungsten leached out from the surface and the surface layer of the lithium nickel cobalt manganese complex oxide, and the catalytic property of the surface of the lithium nickel cobalt manganese complex oxide is significantly enhanced. Presumably as a result, decomposition reaction of the non-aqueous electrolyte solution at the surface of the lithium nickel cobalt manganese complex oxide is accelerated and coating films formed of decomposition products are excessively formed on the surface of the lithium nickel cobalt manganese complex oxide. As a result, the coating films excessively formed function as resistance and inhibit movement of lithium ions, thereby possibly increasing the DC resistance elevation rate after cycles compared to the cell B4.

In the cell B2, a boron-containing carbon material is used as the conductive agent but the lithium nickel cobalt manganese complex oxide does not contain tungsten. In the cell B2, due to boron contained, decomposition reaction of the non-aqueous electrolyte solution at the surface of the boron-containing carbon material (conductive agent) is accelerated. Moreover, in the cell B2, the lithium nickel cobalt manganese complex oxide does not contain tungsten, the catalytic property of the transition metal contained in the lithium nickel cobalt manganese complex oxide is high, and thus the activity of the conductive agent in contact with the surface of the lithium nickel cobalt manganese complex oxide is further enhanced. Presumably as a result, decomposition reaction of the non-aqueous electrolyte solution at the surface of conductive agent is further accelerated and coating films formed of decomposition products are excessively formed on the surface of the conductive agent. As a result, the coating films excessively formed function as resistance and inhibit movement of lithium ions, thereby possibly increasing the DC resistance elevation rate after cycles compared to the cell B4.

In contrast, in the cell A1, the lithium nickel cobalt manganese complex oxide contains tungsten and a boron-containing carbon material is used as the conductive agent. In the cell A1, a boron-containing carbon material is present near the tungsten compound remaining on the surface of the lithium nickel cobalt manganese complex oxide. Presumably thus, as charging and discharging are repeated, tungsten is suppressed from leaching out of the surface and the surface layer of the lithium nickel cobalt manganese complex oxide particles, and the catalytic property of the surface of the lithium nickel cobalt manganese complex oxide can be lowered.

Moreover, in the cell A1, since the lithium nickel cobalt manganese complex oxide contains tungsten, the catalytic property of the lithium nickel cobalt manganese complex oxide can be lowered, and thus, the activity of the conductive agent (boron-containing carbon material) in contact with the surface of the lithium nickel cobalt manganese complex oxide can be lowered.

In other words, it is presumed that, in the cell A1, the decomposition reaction of the non-aqueous electrolyte solution at the surface of the lithium nickel cobalt manganese complex oxide and the decomposition reaction of the non-aqueous electrolyte solution at the surface of the conductive agent can be suppressed and thus excessive formation of coating films formed of decomposition products on the surface of the lithium nickel cobalt manganese complex oxide and the conductive agent is suppressed, and good coating films with excellent lithium ion permeability are formed. Presumably as a result, the DC resistance elevation rate after cycles was smaller than other cells.

### INDUSTRIAL APPLICABILITY

A positive electrode for a non-aqueous electrolyte secondary battery according to an aspect of the present invention can be applied to driving power supplies for electric vehicles (EVs), hybrid electric vehicles (HEVs and PHEVs), and power tools that require long life. Application to mobile information terminals such as cellular phones, notebook computers, smart phones, and tablet terminals can also be expected.

### REFERENCE SIGNS LIST

20 three-electrode test cell
11 working electrode (positive electrode)
12 counter electrode (negative electrode)
13 reference electrode
14 non-aqueous electrolyte solution

1.-5. (canceled)

6. A positive electrode for a non-aqueous electrolyte secondary battery comprising a positive electrode active material comprise a lithium transition metal oxide comprising a lithium nickel cobalt manganese oxide or a lithium nickel cobalt aluminum oxide and a conductive agent,
wherein the positive electrode active material comprises tungsten and the conductive agent comprises a boron-containing carbon material.

7. The positive electrode for a non-aqueous electrolyte secondary battery according to claim 6,
wherein a particle of a compound that contains tungsten exists on the surface of the lithium transition metal oxide.

8. The positive electrode for a non-aqueous electrolyte secondary battery according to claim 7,
wherein tungsten dissolved in the crystals of the lithium transition metal oxide.

9. The positive electrode for a non-aqueous electrolyte secondary battery according to claim 7,
wherein the compound that contains tungsten comprises tungsten oxide or lithium tungstate.

10. The positive electrode for a non-aqueous electrolyte secondary battery according to claim 8,
wherein the compound that contains tungsten comprises tungsten oxide or lithium tungstate.

11. The positive electrode for a non-aqueous electrolyte secondary battery according to claim 6,
wherein the molar ratio of nickel is higher than the molar ratio of cobalt and the molar ratio of manganese in the lithium nickel cobalt manganese oxide.

12. The positive electrode for a non-aqueous electrolyte secondary battery according to claim 6, wherein an amount of tungsten is 0.05 mol % or more and 10.0 mol % or less relative to a total number of moles of metal elements in the lithium transition metal oxide other than lithium.

13. The positive electrode for a non-aqueous electrolyte secondary battery according to claim 6, wherein an amount of boron relative to the carbon material is 0.3% by mass or more and 2.0% by mass or less.

14. A non-aqueous electrolyte secondary battery comprising the positive electrode for a non-aqueous electrolyte secondary battery according to claim 6, a negative electrode that can store and release lithium, and a non-aqueous electrolyte.
